(19) United States
(12) Patent Application Publication
(10) Pub. No.: US 2026/0133896 A1
(43) Pub. Date: May 14, 2026

(54) AUTOMATED TESTING OF EXTRACT, TRANSFORM AND LOAD

(71) Applicant: SHELL USA, INC., Houston, TX (US)

(72) Inventors: Sri Venkateswarlu Bhamidipati, Bangalore (IN); Prasannah Sankaragururaman, Bangalore (IN); Surender Reddy Gummadi, Bangalore (IN); Vinothkumar Selvarajan, Bangalore (IN); Harshavardhan Revanna, Bangalore (IN); Praswith Maramada Uthappa, Bangalore (IN); Amit Haripal, Bangalore (IN); Sreelakshmi Subbanna, Bangalore (IN); Aishwarya Srinivasa Bhat, Bangalore (IN); Sunil Kumar, Bangalore (IN); Sowmya Bidre Ranganatha, Bangalore (IN); Pravin Jebakumar Isac Sundarapandy, Bangalore (IN); Leesharani Nagaraj, Bangalore (IN)

(21) Appl. No.: 19/093,594

(22) Filed: Mar. 28, 2025

(30) Foreign Application Priority Data
Nov. 13, 2024 (IN) 202441087408

(51) Int. Cl. G06F 11/3698; G06F 11/3668; G06F 16/25

(52) U.S. Cl. CPC G06F 11/3698; G06F 11/3688; G06F 11/3692; G06F 16/254

(57) ABSTRACT

A computer-implemented method for automated testing of an ETL process comprising receiving configuration details at a user interface. The configuration details include: program configuration details, project configuration details, test case configuration details, test suite configuration details and connection configuration details. The configuration details are stored in a tool database. A test suite comprises one or more test cases, and one or more test cases are mapped to one or more test suites. One or more test suites are executed. Executing a test suite comprises loading the source data from a source data system and loading target data from a target data system into memory. A library of functions is accessed, and one or more functions are selected according to the configuration details. Using the selected functions, source data and target data are compared. The comparing produces discrepancy results which are stored in the tool database. Test execution results are also stored in the tool database. The method further comprises displaying the discrepancy results and test execution results in the user interface. Discrepancy results include information relating to one or more of the following discrepancies: a missing record discrepancy, an attribute discrepancy, a missing column discrepancy, a data type discrepancy, a value discrepancy, and a duplicate discrepancy.

### TECHNICAL FIELD

The present invention relates to automated testing for Extract, Transform, and Load (ETL).

### BACKGROUND

Extract, Transform, and Load (ETL) processes integrate data from various sources. This involves extracting data from one or more input sources, transforming it, and loading it into a target destination. ETL enables the combination of data from multiple systems, facilitating querying, analysis, decision-making, or application development. Source systems may be managed by different stakeholders and located in diverse places. Data extraction involves retrieving data from these source systems. Data transformation includes tasks such as data cleaning, reformatting, and enhancing data consistency. Data loading involves inserting the transformed data into a final target system.

In some situations, ETL processes can lead to discrepancies or mismatches between the source and target data. As a result, the target data may become unreliable for decision-making or further analysis.

The embodiments described below are provided by way of example only and are not limiting of implementations which solve any or all the disadvantages of known testing methods.

### SUMMARY

This summary is provided to present a selection of concepts disclosed herein in a simplified form, which are described in more detail below. This summary is not intended to identify key features or essential features of the claimed subject matter nor is it intended to be used to limit the scope of the claimed subject matter.

A computer-implemented method for automated testing of an ETL process comprising receiving configuration details at a user interface. The configuration details include: program configuration details, project configuration details, test case configuration details, test suite configuration details and connection configuration details. The configuration details are stored in a tool database. A test suite comprises one or more test cases, and one or more test cases are mapped to one or more test suites. One or more test suites are executed. Executing a test suite comprises of reading the data from source data from a source data system and loading target data from a target data system into memory. A library of functions is accessed, and one or more functions are selected according to the configuration details. Using the selected functions, source data and target data are compared. The comparing produces discrepancy results which are stored in the tool database. Test execution results are also stored in the tool database. The method further comprises displaying the discrepancy results and test execution results in the user interface. Discrepancy results include information relating to one or more of the following discrepancies: a missing record discrepancy, an attribute discrepancy, a missing column discrepancy, a data type discrepancy, a value discrepancy, and a duplicate discrepancy.

### DESCRIPTION OF THE DRAWINGS

The present description will be better understood from the following detailed description read in light of the accompanying drawings, wherein:

FIG. 1 is a schematic diagram showing aspects of a system for testing an ETL process;

FIG. 2 is a schematic diagram showing an arrangement of test cases, test suites, projects and programs;

FIG. 3 shows examples of source data and target data;

FIG. 4 shows examples of source data and target data;

FIG. 5 shows an example user interface page;

FIG. 6 shows an example user interface page;

FIG. 7 shows an example user interface page;

FIG. 8 shows an example user interface page;

FIG. 9 shows an example user interface page;

FIG. 10 shows an example user interface page;

FIG. 11 shows an example user interface page;

FIG. 12 shows an example user interface page;

FIG. 13 shows an example user interface page;

FIG. 14 shows an example user interface page;

FIG. 15 shows an example user interface page;

FIG. 16 shows an example user interface page;

FIG. 17 shows an example user interface page;

FIG. 18 shows an example user interface page;

FIG. 19 shows an example user interface page;

FIG. 20 shows two example pages of a user interface;

FIG. 21 is a schematic diagram showing a computer-implemented method for testing an Extract, Transform, and Load process; and

FIG. 22 illustrates an example computing-based device.

### DETAILED DESCRIPTION

The following description is presented in connection with the appended drawings and is intended as a description of the present examples to enable a person skilled in the art to make and use the invention. The description is not intended to represent the only forms in which the present examples are constructed or utilized. The present invention is not limited to the embodiments described herein and various modifications to the disclosed embodiments will be apparent to those skilled in the art.

With frequent changes in the current world of technology and innovation, and a heavy reliance on data for decision-making there is a need for ensuring that data present in any system is reliable and valid. Extract, Transform, and Load (ETL) processes combine data from multiple sources. This involves extracting data from one or more input sources, transforming it, and loading it into a target destination. ETL enables the combination of data from multiple systems, facilitating querying, analysis, decision-making, or application development. Source systems may be managed by different stakeholders and located in diverse places. Data extraction involves retrieving data from these source systems. Data transformation includes tasks such as data cleaning, reformatting, and enhancing data consistency. Finally, data loading involves inserting the transformed data into a final target system.

As used herein, source data is data input into an ETL process and target data is data produced from the source data during the ETL process. Source data is contained in a source system and target data is contained in a target system.

ETL processes are performed in some scenarios manually by a system operator and in other scenarios the processes are automated using ETL software. For example, ETL software may transform source data using a transform rule before being loaded into a target system.

ETL may result in inconsistencies, discrepancies, or mismatches between source data and target data. As a result, the target data may become unreliable for decision-making or further analysis. Identifying discrepancies between source data and target data allows the discrepancies to be reconciled and issues with the ETL process to be fixed. Source data and target data may comprise millions of data entries, making validating the ETL process challenging. To manually validate the source and target data would take many human hours.

The methods disclosed herein provide ways to test and review the ETL process performed on large datasets in a computationally efficient and user-friendly manner. The present disclosure relates to systems and methods for testing an ETL process by comparing source and target data. As used herein, discrepancy, inconsistency and mismatch are interchangeable terms relating to unexpected differences between source and target data. Disclosed methods include the use of a user interface (UI) which allows a user to configure test scenarios, execute testing, and view test results and execution results in a user-friendly and computationally efficient manner. This is particularly advantageous where the user does not possess the degree of technical expertise required to use the testing framework.

Although the present disclosure is described with reference to an ETL process, the methods described herein are applicable to other processes wherein a source data and target data are compared to establish whether the datasets are consistent with each other. For example, methods described herein are also applicable to Extract, Load and Transform (ELT).

Methods described herein are suitable for use with many different databases, data systems and data types. An ETL process which is automatically tested as described herein may be used in various technical applications. For example, the data could relate to data relating to a production or extraction process. The data could contain details of oil or natural gas extraction processes including volume of oil extraction, location of extraction, and oil composition. ETL can be used to collect data from various sources (e.g. different sites or countries) and combine data from different sources into a central database. Data in the central database could be used to make decisions about where to further extract more of a resource and how to extract the resource.

In further examples the data is data describing financial transactions such as sales and includes currency, amount of currency, seller, buyer, bank details and other relevant information. In one example, sales information from different countries is processed using an ETL process to produce a global sales dataset as a target dataset.

The data in other examples is sensor data collected from cameras, temperature sensors or other sensors. Sensor data may be collected from a plurality of remote devices, and ETL is used to move data from the remote devices to a centralized location. In further examples, data other than sensor data is collected from remote devices and ETL is performed on this data additionally or alternatively. Remote devices include internet of things (IoT) devices with sensors. Example IoT devices include wearable devices, smartphones and network devices. In further examples, sensor data includes image data from a camera such as a visible light camera, an infrared camera or a depth camera. Image data may be collected from a plurality of cameras imaging or scene or imaging multiple scenes in different locations, and ETL can be used to move image data from cameras to a central database.

In a specific scenario, ETL is used to move data from a plurality of remote devices to a centralized database. The centralized database may then be used to process the data and to automatically perform an action. For example, the action is controlling one or more of the remote devices. The location of a remote device may be changed, a remote device may be turned on or off, a remote device may perform a measurement action, or a remote device may adjust its settings. For example, a remote device includes a camera and the action is to capture an image using a camera. In another example the remote device is a drone or a car and the action is to change the location of the drone or car. In another example, the remote device is a refrigerating device and the action is to adjust the temperature of the device. In another example the remote device is a wearable device and the action is to display content to the wearer of the device.

In various scenarios, the target data is used for further analysis for example using machine learning or artificial intelligence or other types of computational analysis. In various examples the target data is used as training data for a machine learning model. Target data may also be used as input data for generating decision making reports.

As mentioned above, methods disclosed herein provide ways to test and review an ETL process and furthermore to automatically improve the ETL process using test results. Based on discrepancy results produced by an ETL process, which are described in detail below, a computer system may automatically improve the ETL process for example by making automatic changes to the target database or changes to a computer program which performs the ETL process. Automatic changes in some scenarios cause the computer program to be more efficient and less error prone. Disclosed herein is an ETL Test Automation Tool (ETAT). A computer-implemented method for automated testing of an ETL process comprising receiving configuration details at a user interface. The configuration details include: program configuration details, project configuration details, test case configuration details, test suite configuration details and connection configuration details. The configuration details are stored in a tool (ETAT) database. A test suit comprises one or more test cases, and one or more test cases are mapped to one or more test suites. One or more test suites are executed.

During test case configuration in which test case configuration details are provided by a user, a user may select a test case type from a drop down menu based on the test cases they plan to execute. Executing a test suite in some examples involves connecting to the source and target systems using the provided configuration details, and then reading data from both systems. The test execution results are stored in a tool database. Source and target data are compared, and discrepancy results are stored in the tool's database. In various scenarios, source data and target data are loaded temporarily into memory and not stored in the tool database Data discrepancies may include missing records, attribute mismatches, missing columns, data type mismatches, value mismatches, duplicates, and count discrepancies. Both the test execution results, and discrepancy results may be displayed on the user interface (UI).

Comparison of source data and target data produces discrepancy results. The type of discrepancy which is identified and reported during testing is determined by test case configuration details provided by a user at the user interface. In various examples described below, the source data and target data share primary keys, or primary IDs, which are identifiers of a particular data record. A record as used herein refers to a row in a data table which is identified by the primary key. For each test case, the user may select a test case type and based on the test case type, the computer system selects discrepancies to identify. In various examples, the following discrepancies between source and target data are identified and reported.

Attribute discrepancy: This is where an attribute in the source data does not match the corresponding attribute in the target data. In other words, an expected attribute value (from the source data) does not match an actual attribute value (from the target data). Attribute discrepancies in examples include a primary key and column name in order to identify the location of the inconsistent attribute in source and target data.

They also include source value and target value being the inconsistent attribute values.

Missing record discrepancy: There is a record in the source data which does not appear in the target data. Alternatively there is a record in the target data which does not appear in the source data. In examples a missing record discrepancy includes information about whether a record is missing in source data or target data, and a primary key identifying the missing record.

Missing column discrepancy: There is a column or field present in the source data which is not present in the target data. Alternatively there is a column or field present in the target data which is not present in the source data. Missing column discrepancies in examples include information about whether a column is missing is source data or target data. A column name identifies the missing column.

Data type discrepancy: A column/field has a different data type in the source data compared to the target data. In examples a data type discrepancy includes information identifying a column name and a source data type and a target data type for the identified column.

Duplicate discrepancy: A duplicate record appears in the source data and/or target data. In examples a duplicate discrepancy includes information about whether a record is duplicated in source data and/or target data, a primary key to identify the record and the number of times the record is duplicated.

Value discrepancy: This compares a single (e.g. binary) value returned from source and target. For example, identifying value discrepancies comprises count validation between source and target, or a check as to whether there is any blank value present for mandatory fields in the target systems.

Test execution is performed using reuseable functions from a library of functions. The reuseable functions are methods or operations performed by a core comparison engine to compare source and target data. During test execution, functions are selected according to configuration details and used to compare source and target data. Some example reusable functions stored in the target database and used during testing are:
readExcelFiles(folderLocation): a function for reading multiple excel files from the same folder located at folderLocation and returning the dataset in a dataframe format
compareSrcTgtSchema(src, tgt, metaCols, RUN_ID, TEST_CASE_ID): used for comparing the source and target table's schema by excluding the fields passed in the metacols parameters (columns relating to metadata). Returns RUN_ID and TEST_CASE_ID which may be used as identifiers during the testing process. Each test case has a corresponding TEST_ID. A new RUN_ID is generated whenever a test case is executed. src is source data and tgt is target data.
generateDataCompareQuery(srcView, tgtView, bkeys, metaCols): This function helps to fetch user defined source and target validation queries and reframe as per ETAT tool required format. The reframed query is used to validate the values between source and target systems and not for schema validation. SrcView is a source validation query. tgtView is a target validation query. bkeys are primary keys (also called primary IDs). A primary key identifies a data record or data row in a database. metaCols are columns including metadata and these fields are excluded from testing.
generateDataCompareQueryOptimised(srcView, tgtView, bkeys, metaCols): Once the user defined queries are reframed in the required format (as mentioned above) then this functions helps to compare the source and target datasets by using the primary keys, identifying discrepancies and generating the results
generateDuplicateCheckQuery(tableName, bkeys): function generates the query for finding duplicate records based on primary keys (bkeys). A primary or primary key is a key which identifies a unique record or data row in a database. The user provides the table name (tableName) in the test case to find the duplicate from that table using this function.
def unpivotAndStoreDataMismatchResults (tableColumns, bkey, run_id, tc_id): This function is used to unpivot mismatched data records and display the actual column having the mismatch in rows.

Test execution is performed at a computer system comprising a core comparison engine. In examples, the core comparison engine is a notebook such as an Azure Databricks notebook (trademark). A test suite execution job is run in the core comparison engine using a job executor pipeline. The data pipeline in various examples is an Azure Data Factory (trademark) pipeline. The core comparison engine reads configuration details from the tool database. In various examples the tool database is an SQL database such as a Microsoft SQL database (trademark). Using the configuration details stored in the tool database, the core comparison engine performs the tests (also called data validations) using reuseable functions such as the reuseable functions above. In various examples, the core comparison engine executes one or more test suites in parallel. A test suite is a grouping of one or more test cases, as explained further below. The system is configured such that a first test suite triggered by a first project may be executed in parallel with a second test suite triggered by a second project at the core comparison engine. In various examples test execution is performed in the cloud. The UI is hosted in cloud and accessed through any browser, at which the user provides configuration details and/or views results. The UI is connected to the other cloud services via a network connection. In some examples a network connection connects the UI to the core comparison engine and to the tool database.

Methods disclosed herein have the following advantages. User navigation is improved by providing a single UI platform application for end-to-end data validation. The same user interface is used to provide configuration details, to view test execution details and discrepancy results produced by comparing source and targe data. Also, parallel execution is facilitated by combining test cases into test suites. Parallel execution of multiple validation jobs allows for lower compute time and improves efficiency. Advantageously, during test suite execution, source data and target data are loaded temporarily in memory. Comparing source and target data produces discrepancy results which are stored in the tool database. Storing only discrepancy results rather than all of the source and target data in the tool database saves memory in the tool database. In various scenarios, discrepancies are searched for and identified throughout all of the source and target data rather than taking a sample of source data and target data for testing. This means that ETL testing is carried out more effectively and inconsistencies in the source and target data are not missed. Source and target data are loaded temporarily in memory from source and target systems respectively, without storing the data physically making ETL testing more efficient.

In various examples, various organization members belong to different programs and projects. In scenarios, the methods disclosed herein improve security by only allowing users of the testing tool to view data and test results, and configure tests, relating to the projects to which they belong. A first example user is a tool administrator (admin) who has access to configure and view all programs, projects, test suites and test cases. A second example user is a project administrator who is able to configure test cases and test suites for the project to which they have permission to access. A third example user is not a tool administrator or a project administrator, but is for example a viewer. The viewer is not able to configure any programs, projects, tests or test suites but is able to view test execution results and test discrepancy results for the projects with which they are associated. Thereby data security and privacy are improved. Disclosed herein is a computer-implemented method comprising receiving configuration details at a user interface. Providing a user interface for receiving configuration details means that the user can input configuration details even when the user lacks skills such as coding skills. The configuration details include: program configuration details, project configuration details, test case configuration details, test suite configuration details and connection configuration details. Receiving these configuration details allows the user to configure various aspects of ETL testing within the same user interface and in a user friendly manner. The configuration details are stored in a tool database. Storing configuration details means that they can be accessed by a core comparison engine which executes tests. The configuration details can also be accessed by the UI for display in order to help the user to understand test results.

A test suite comprises one or more test cases, and one or more test cases are mapped to one or more test suites. One or more test suites are executed. Executing test suites comprising one or more test cases makes testing more efficient. Executing a test suite comprises loading the source data from a source data system and loading target data from a target data system into memory. Loading temporarily into memory rather than storing in the tool database makes testing more memory efficient. A library of functions is accessed, and one or more functions are selected according to the configuration details. Using the selected functions, source data and target data are compared. The library comprises reuseable functions so that the same functions may be used for different test cases and test suites. This saves developer time and allows a user with less skill (e.g. coding skills) to perform ETL testing. The comparing produces discrepancy results which are stored in the tool database. Storing discrepancy results in the tool database means that the results can be accessed and displayed to the user in the UI. Discrepancy results and not source and target data are stored in the tool database, making the testing more memory efficient. Test execution results are also stored in the tool database. This means that test execution results can be accessed and displayed in the UI. Allowing the user to view test execution results means that the user can monitor their tests in a user friendly way, and avoid execution errors.

The method further comprises displaying the discrepancy results and test execution results in the user interface. Discrepancy results include information relating to one or more of the following discrepancies: a missing record discrepancy, an attribute discrepancy, a missing column discrepancy, a data type discrepancy, a value discrepancy, and a duplicate discrepancy. These discrepancy types are all useful discrepancy types for the user, who can then determine whether target data is suitable for further use. Discrepancies are identified such that problematic discrepancies can be fixed before the data is used further.

In various examples, discrepancy results are used to automatically improve the ETL process used to convert the source data to target data. For example, methods may include automatically improving the ETL process for example by making automatic changes to the target database and/or changes to a computer program and/or source code which performs the ETL process. In an example, upon identifying a missing record or column discrepancy wherein there is a record/column in the source data which does not appear in the target data, the method may include performing a separate ETL process on that record/column from the source data so that it is included in the target data. If a record or column is included in the target data which is not included in the source data, the method may include removing the record/column from the target data. Where a duplicate discrepancy is identified, the method may include removing one of the duplicate records. Where a data type discrepancy is identified, the method may include changing the data type of a column/field in the target data in order to match the source data. Where a value discrepancy is identified, the method may include adjusting the target data so that its values match the source data. To automatically improve the ETL process, rules are used in some cases. A condition of a rule may be matches by features of a discrepancy and an actin of a rule may comprise instructions for automatically improving the ETL process.

In examples, an ETL process may be automatically improved by automatically adjusting a computer program or source code used to perform the ETL process. Discrepancy results may be processed for example using a large language model LLM in order to identify and automatically improve problematic parts of source code. In some examples, discrepancy results from one or more tests are extracted from the tool database and analyzed for example using machine learning in order to find improvements to the computer program or source code. In various scenarios, changes are made to the ETL process which make the process more effective, more efficient and less error prone. This saves computational resources during ETL. In an example, the discrepancy is added to a prompt together with details of the ETL process. The prompt is sent to a generative machine learning model asking for suggestions how to modify the ETL process to reduce the discrepancy. The suggestion comprises source code or other instructions which are automatically used to trigger change in the ETL process.

Methods for testing an ETL processes are described below with reference to the accompanying figures.

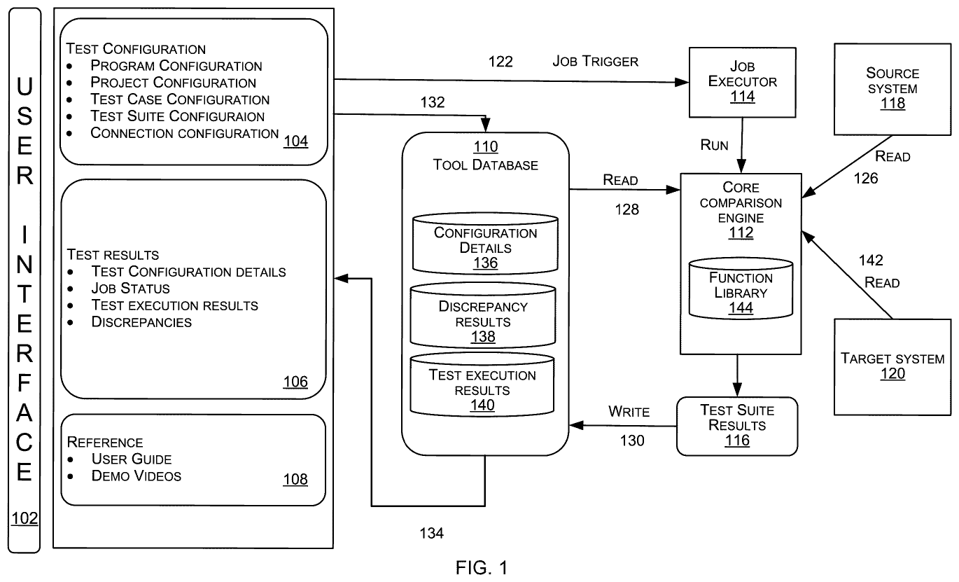

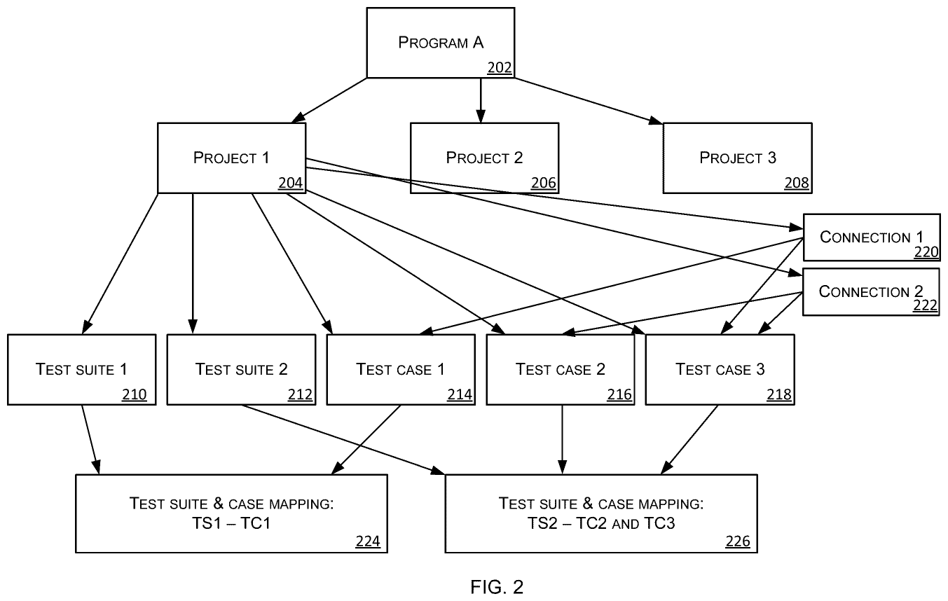

FIG. 1 is a schematic diagram showing aspects of a system for testing an ETL process. A user interface 102 allows the user to interact with the system, providing a single platform for end-to-end validation. At 104 the UI facilitates test configuration. The UI allows the user to input testing configuration details. These include program configuration details, project configuration details, test case configuration details, test suite configuration details and connection configuration details. Providing configuration details allows the user to manage programs, projects, test cases and test suites. Various pages of the user interface allow the user to provide the various configuration details described above to the system in an efficient and user friendly manner. As explained in more detail below with reference to FIG. 2, the various tests are grouped and structured according to a framework. A test suite is a group of one of more test cases. Once the configuration details are received at 104, the configuration details are written 132 into tool database 110. Configuration details 136 are stored in tool database 110 for later use by core comparison engine 112.

Job executor 114 orchestrates and automates testing jobs. In some examples job executor 114 is Azure Data Factory (trademark). A job executor pipeline is triggered at 122. The pipeline is triggered by the user via the user interface. For example, the user triggers the data pipeline by pressing a button in the user interface called “run test”. Job executor 114 manages and deploys cloud infrastructure for testing. In various examples, tests are run in the cloud at core comparison engine 112. Testing tasks are scheduled and managed via job executor 114. Job executor 114 orchestrates the execution of one or more test execution jobs. In various examples, the test execution job is an Azure Databricks job. In further examples, the Azure Databricks job is an azure Databricks notebook. Core comparison engine 112 performs data comparisons between the source data and target data. In various examples, the core comparison engine is an Azure Databricks notebook. Core comparison engine 112 reads 126, 142 source data from source system 118 and target data from target system 120. Source data and target data are data related to a technical application. Example data include but are not limited to: data related to extraction of a resource such as oil or gas, data from a remote device such as an internet of things, IoT, device, data from a remote sensor, data from a camera. Source system 118 and target system 120 in some examples are different systems. For example, the systems may be managed by different stakeholders. The source and/or target system may be a file system or database system. A file system organizes data into files and directories. A database system organizes data into tables.

Core comparison engine 112 also reads configuration details 136 from tool database 110. In various examples, tool database 110 is an Azure SQL Database. Using the configuration details 136, source data and target data, core comparison engine 112 produces test suite results 116 comprising discrepancy results 138 and test execution results 140. Test execution results 140 include details about the test execution such as run time, errors, job start time, job end time, jobs status, total number of tests, total number of failed tests, total number of passed test, total number of test suites, number of passed test suites and number of failed test suites, a summarized result (e.g. counts of source/target system, number of matched and missed records), job failure error logs, other suitable details.

Core comparison engine 112 is designed to be reused across different test cases, test suits, programs or projects. Tasks performed by the core comparison engine include: connecting to different databases and files (source and target databases, excel files), accessing data from different databases and files (e.g. source and target data, excel files) and using reusable functions in order to perform the comparisons.

At 130 test suite results 116 including discrepancy results 138 and test execution results 140 are written to the tool database 110. FIG. 1 shows that in tool database 110, the test suite results are stored 138 and the test execution results are stored 140. In various examples, tool database 110 is a Microsoft SQL Server. Tool database 110 stores, retrieves, and manages data as requested by various application such as the core comparison engine, which may run on the same computer or on another computer across a network.

User Interface 102 allows the user to view test execution results and test suite results so that the user can assess ETL. At 134, data from the tool database 110 is read and at 106 test results are presented for the user to view. Test results comprise test execution results and discrepancy results. Discrepancy results displayed to the user include: attribute discrepancy, missing record discrepancy, missing column discrepancy, data type discrepancy, duplicate discrepancy and value discrepancy. In various examples, a summary report of the discrepancies is displayed. A summary report may be generated using Power BI (trademark), or any other suitable method. Test execution results including job status are also displayed for the user at the UI. Test configuration details may also be displayed for user reference. A job error log report may also be displayed. In some examples, the UI also includes reference information 108 for the user to access, including user guides and demo videos.

In further examples, additionally or alternatively to displaying discrepancy results in a user interface, the system shown in FIG. 1 may use discrepancy results to automatically improve the ETL process. The automatic improvement in some scenarios is performed by core comparison engine 112. In other scenarios the automatic improvement is performed by an improvement engine (not shown in FIG. 1). Automatically improving the ETL process sometimes comprises making automatic changes to the target database. Additionally or alternatively, automatically improving the ETL process sometimes comprises making automatic changes to a computer program and/or source code which performs the ETL process.

Examples of automatically improving the ETL process by making changes to target data based on discrepancy results include the following. Upon identifying a missing record or column discrepancy wherein there is a record/column in the source data which does not appear in the target data, the computer system performs a separate ETL process on that record/column from the source data so that it is included in the target data. If a record or column is included in the target data which is not included in the source data, the computer system may remove the record/column from the target data. Where a duplicate discrepancy is identified, the computer system may remove one of the duplicate records. Where a data type discrepancy is identified, the computer system may change the data type of a column/field in the target data in order to match the source data. Where a value discrepancy is identified, the computer system may adjust the target data so that its values match the source data.

FIG. 2 is a schematic diagram showing an arrangement of test cases, test suites, projects and programs. At the top of the diagram is program A 202. An example of a program is an “upstream program” or a “downstream program”. Program A 302 in FIG. 2 comprises three projects, project 1 204, project 2 206 and project 3 208. FIG. 2 shows test suites and test cases associated with project 1 204. Although not shown in FIG. 2, project 2 206 and project 3 208 also have associated test cases and test suites. A test suite is a group of test cases. In other words, a test suite is a logical container which is a holder of test cases. A test case is a single test on a source database, a target database, with associated discrepancies to identify during testing. As shown at 224, test case 1 214 is mapped to test suite 1 210. As shown at 226, test case 2 216 and test case 3 218 are mapped to test suite 2. Connection 1 220 is an example connection to a data system. Connection 2 220 is another example connection to a data system. Connections 220 and 220 may be connections to source or target data systems. The connections are established according to connection configuration details provided by the user. Arrows between connections and test cases in FIG. 2 represent that the test case using the connection to connect to a source or target database. Test case 1 214 for example uses connection 1 220 to connect to a source or target database, as represented by an arrow in FIG. 2.

Multiple test cases are grouped into test suites. A test suite includes tests which are intended to test different aspects of the ETL process. ETL test cases include but are not limited to count validation, data validation, data quality checks (e.g. duplicate checks) and structure validation. Test cases and test suites are further organized into projects and programs. A project comprises one or more test suites. A project delivers one or more specific applications. A program is a collection of related projects. Within an organization, various teams and individuals are associated with different programs and/or projects. Example programs are an “upstream program” and a “downstream program”. An example project is a “master data project” which belongs to the “upstream program”. Within a “master data project” data from many sources is collected. For example, exploration data e.g. location information, amount of oil, oil composition from multiple sources is combined in the “master data project”. Another example project is a “production and volume project” which also belongs to the “upstream program”. The project is associated with data regarding volume and location. In further examples, “downstream program” relates to sales such as website sales. Within the downstream program there are projects related to combining sales from multiple websites.

Pages of the UI allow the user to input configuration details regarding at least one or more of: program, project, connection, test case and test suite.

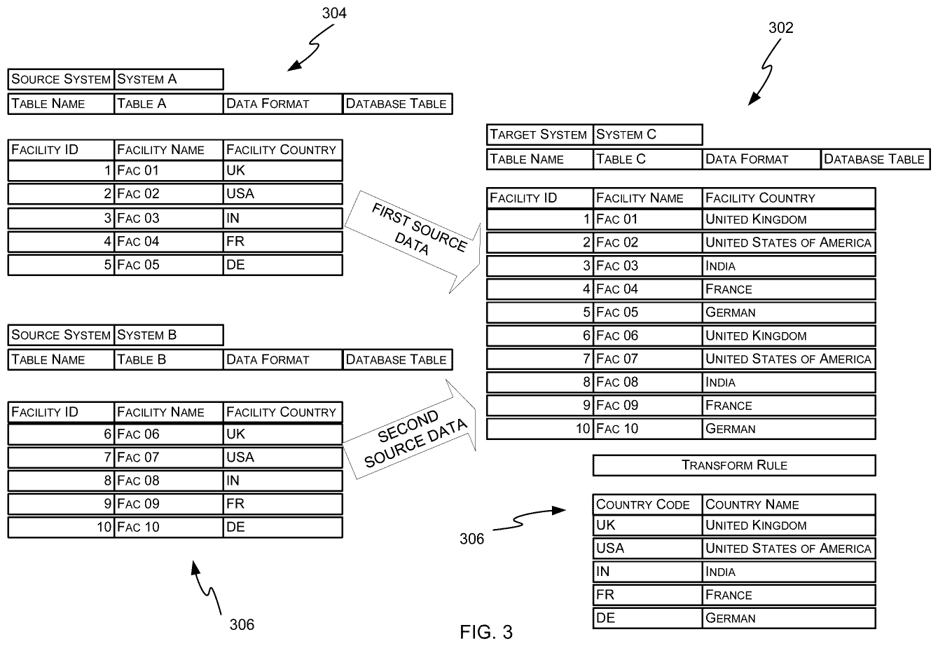

FIG. 3 shows examples of source data and target data. 304 is example source data from a first source system and 306 is example source data from a second source system. The data in FIG. 3 is presented purely as an example which relates to facilities for resource extraction. The source data comes from two different systems, which are database systems. First source data 304 comes from a source system called “EC” and second source data 306 comes from a source system called “SEPCO”. Source data 304 is in the format of a database table and the table name is “EC facility”. There are three columns and five rows in source data 304. The column headers are “facility ID”, “facility name” and “facility country”. Source data 306 is in the format of a database table and the table name is “SEPCO facility”. There are three columns and five rows in source data 304. The column headers are “facility ID”, “facility name” and “facility country”.

302 is sample target data which is the output of an ETL process. The ETL process has combined first source data 304 and source data 306. The format of target data 302 is a database table, the table name is “SMD facility” and the target system is called “SMD”. The target data table has three columns and 10 rows. The column headers are “facility ID”, “facility name” and “facility country”. In FIG. 3 there are no discrepancies or mismatches between the source data and the target data.

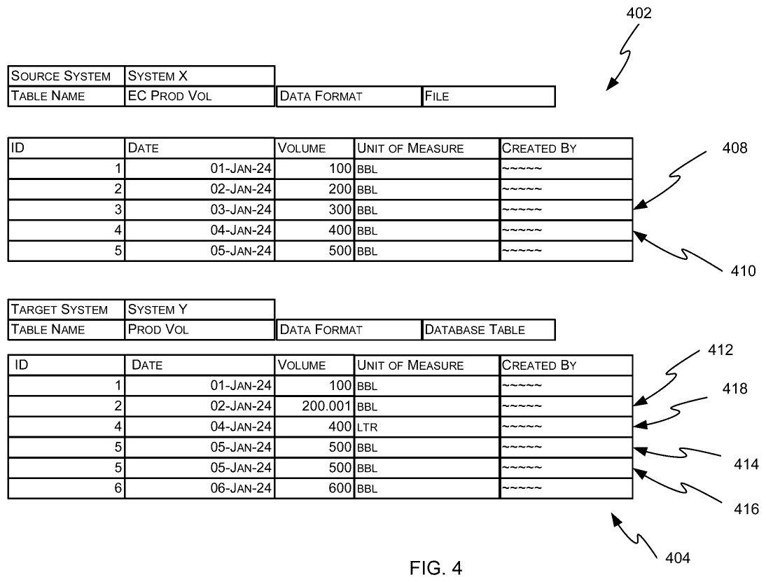

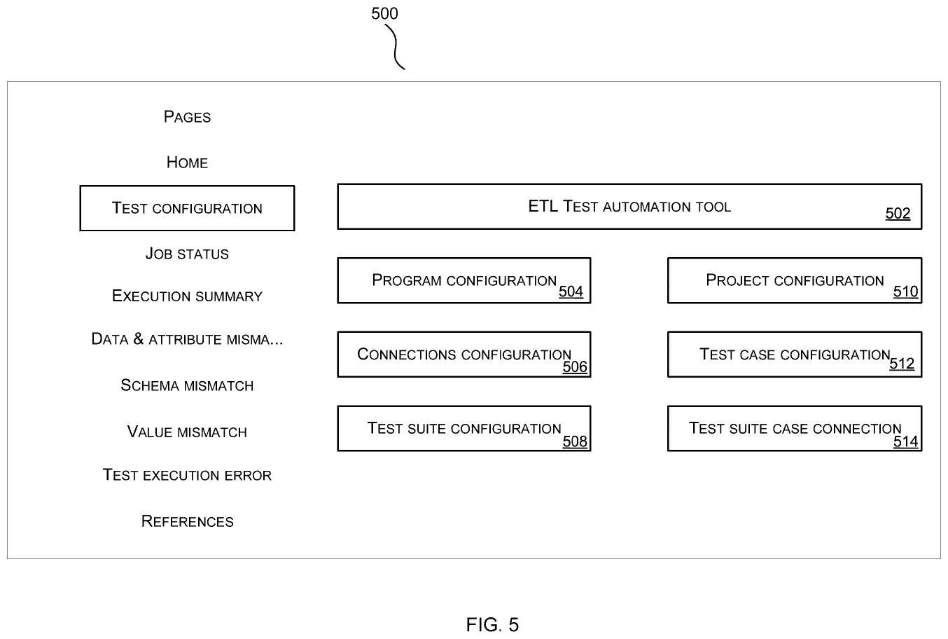

FIG. 4 shows further examples of source data 402 and target data 404 which relates to resource extraction. As explained above, other data types are used in further examples including data from remote devices, or sensor data from sensors including cameras and temperature sensors. In FIG. 4, source data and target data is for example part of a “production and volume project” which is part of an “upstream program”. Source data 402 is from a source system called “EC”. The format of source data 402 is a file and the source system is a file system. Target data 404 is from a target system called “Production & Volume” and the data format is database table. Various discrepancies or inconsistencies between source data 402 and target data 404 may be identified. It can be seen that the third row of the source data 408 with “Facility ID”=3 is not present in the target data. This is an example of a missing record discrepancy. Meanwhile in the target data 404 there are two entries 414 and 416 with “Facility ID”=5 which are duplicate entries. The entry with “Facility ID”=5 is not duplicated in the source data 402. This is an example of a duplicate discrepancy. There is also a record in target data 404 with “Facility ID”=6 which is not present in source data 402. This is another example of a missing record discrepancy. Regarding the second row of source data 402 and the second row 412 of target data 404 (“Facility ID”=2) the value of the “Volume” column in the source data is “200” but the value of the same column in the target data is “200.001”. This is an example of an attribute mismatch. Regarding the rows in source data 402 and target data 404 with “Facility ID”=4, the value in the “Unit of Measure” column is “Itr” in the target data at 418, but the value is “bbl” in the source data at 408. This is an example of an attribute mismatch. An example of a value mismatch is the mismatch between the number of rows in source data 402 compared to target data 406. Source data 402 has a row count of five and target data 404 has a row count of six. This is an example of a value mismatch or value discrepancy. Methods for testing an ETL process such as the process used to generate example target data from source data shown in FIG. 3 and FIG. 4 are facilitated using a user interface (UI) such as the UI shown in FIGS. 5-19.

FIG. 5 shows an example user interface (UI) 500. On the left of the user interface there is a navigation panel showing various pages of the UI. The UI in FIG. 5 is showing the “Test Configuration” page 502. The “Test Configuration” page 502 facilitates a user entering various configuration details via the UI 500. Page 502 incudes panels 504, 506, 508, 510, 512, 514 which allow the user to navigate to further pages to enter configuration details which related to program configuration, connections configuration, test suite configuration, project configuration, test case configuration and test suite case connection.

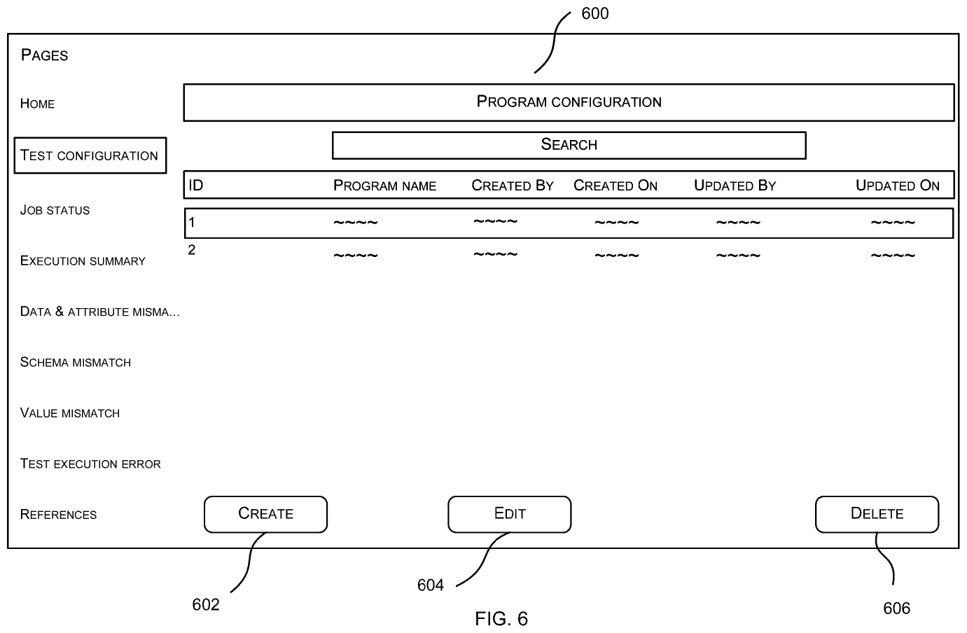

FIG. 6 shows an example of a “Program Configuration” page 600 in the UI wherein the user views program configuration details and provides configuration details for new or existing programs. In an example scenario, the user has navigated to the “Program Configuration” page from the “Test Configuration” page and the button 504 shown in FIG. 5. “Program Configuration” page 600 shows various programs which have been configured. Button 602 allows the user to create a new program. Button 604 allows the user to edit program. Button 606 allows the user to delete a program. Search functionality is also provided so that the user can search for a desired program. The search is a dynamic search which generates a new query each time a new character is entered into a search box. The program configuration page of the UI allows the user to enter program configuration details including program name.

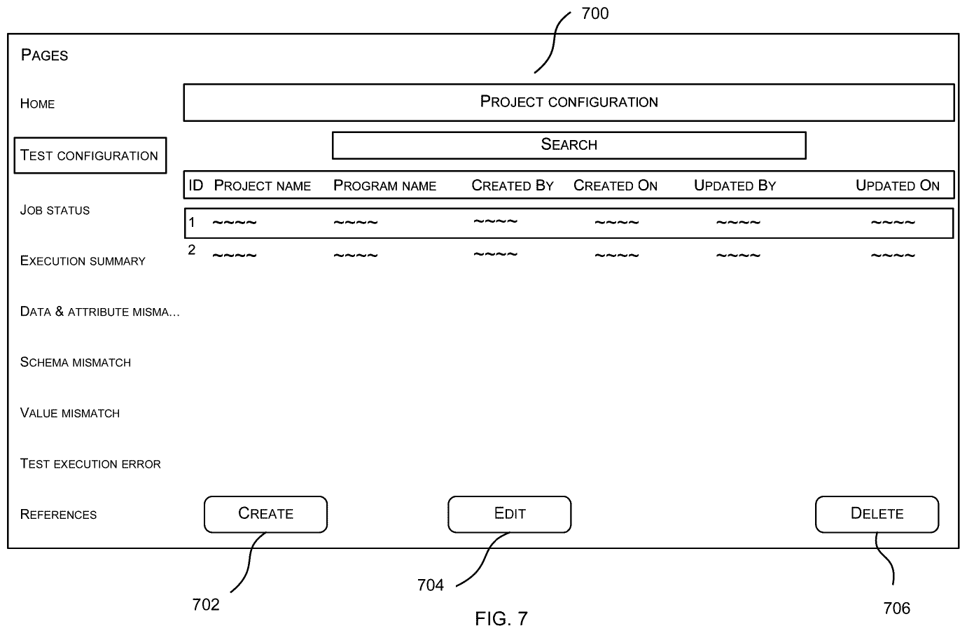

FIG. 7 shows an example of a “Project Configuration” page 700 in the UI wherein the user views project configuration details and provides configuration details for new or existing projects. In an example scenario, the user has navigated to the “Project Configuration” page from the “Test Configuration” page and the button 510 shown in FIG. 5. Each project is associated with a program and this information is displayed at page 700. “Project Configuration” page 700 shows various projects which have been configured. Button 702 allows the user to create a new project. Button 704 allows the user to edit a project. Button 706 allows the user to delete a project. Search functionality is also provided so that the user can search for a desired project. The search is a dynamic search which generates a new query each time a new character is entered into a search box. The example project configuration page in FIG. 7 enables the user to choose a program name from a dropdown list, after which they enter the project name as part of the configuration process.

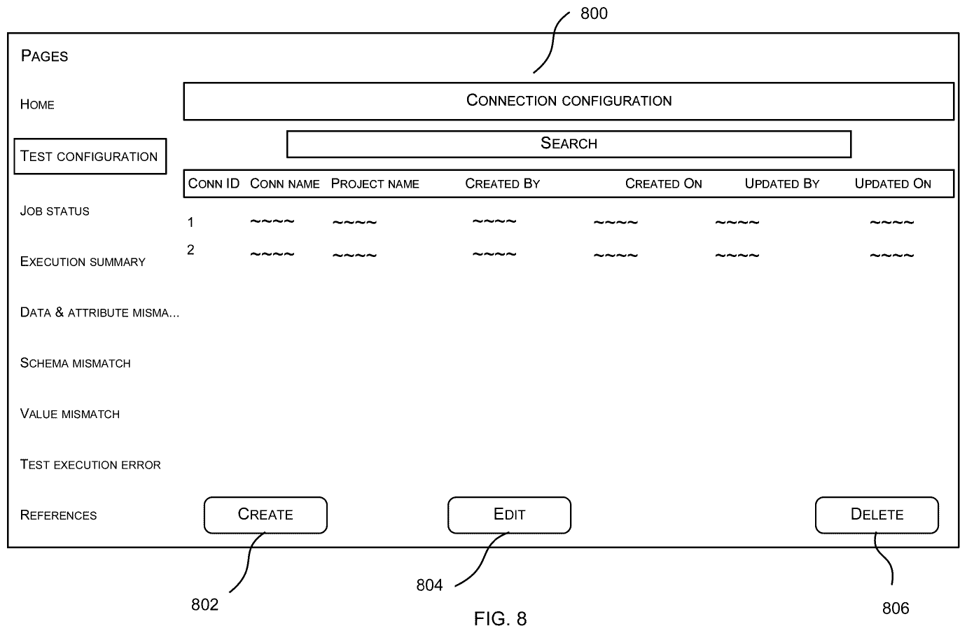

FIG. 8 shows an example of a “Connection Configuration” page 800 in the UI wherein the user views connection configuration details and provides connection configuration details for new or existing connections. In an example scenario, the user has navigated to the “Connection Configuration” page from the “Test Configuration” page and the button 506 shown in FIG. 5. Each connection is associated with a project and this information is displayed at page 800. “Connection Configuration” page 800 shows various connections which have been configured. Button 802 allows the user to create a new configuration. Button 804 allows the user to edit a connection. Button 806 allows the user to delete a connection. The search is a dynamic search which generates a new query each time a new character is entered into a search box. The connection configuration page allows the user to select a desired connection type and enter connection configuration details which allow the core comparison engine 112 to connect to the source system and target system in order to load source and target data.

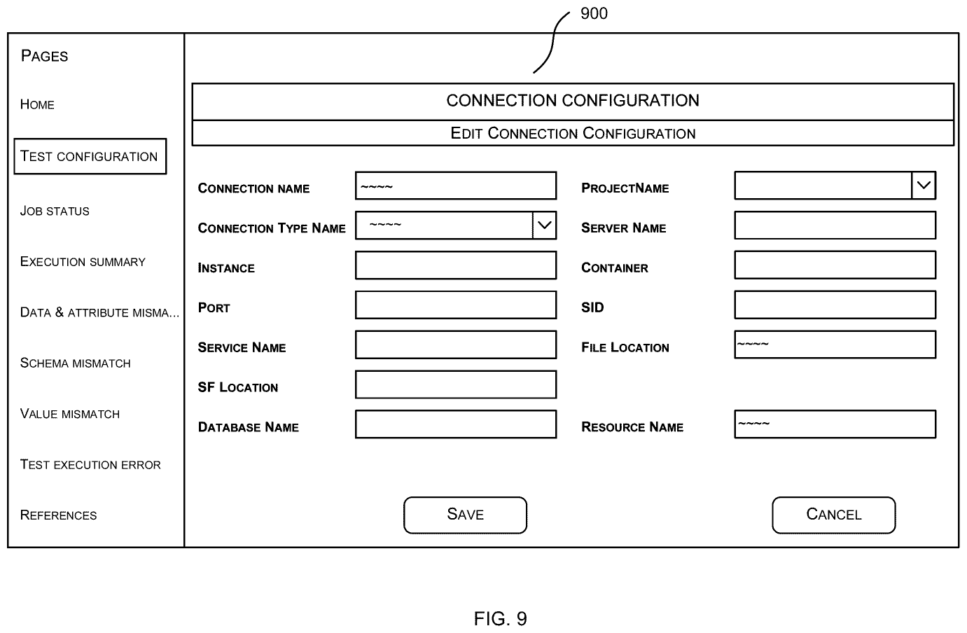

FIG. 9 is an example page 900 in the UI which allows the user to edit a connection configuration. For example, the user arrives at this page through button 804 in FIG. 8. The user provides connection configuration details including: connection name, project name, connection type name, server name, instance, container, port, System Identifier (SID), service name, file location, Share Folder location (SF), database name and resource name. In various examples such as the example in FIG. 9, the project name is selected form a drop-down menu of existing projects configured for example at page 700. Connection type name may be selected from a drop-down menu of connection types which are supported. In the example in FIG. 9, the connection type name is Azure Datalake.

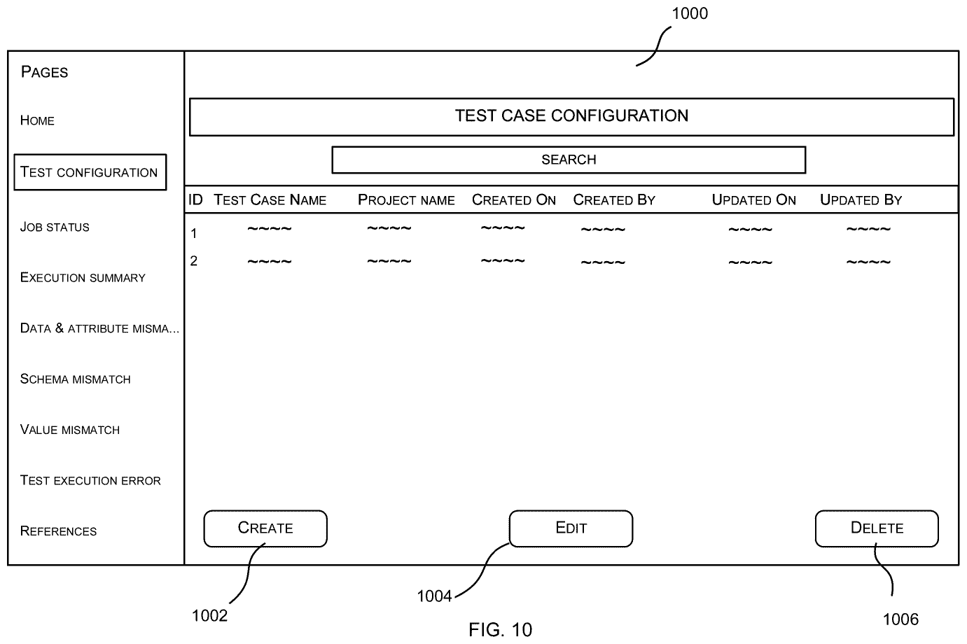

FIG. 10 shows an example of a “Test Case Configuration” page 1000 in the UI wherein the user views test case configuration details and provides test case configuration details for new or existing test cases. In an example scenario, the user has navigated to the “Test case Configuration” page from the “Test Configuration” page and the button 506 shown in FIG. 5. Each test case is associated with a project and this information is displayed at page 1000. “Test case Configuration” page 1000 shows various test cases which have been configured. Button 1002 allows the user to create a new configuration. Button 1004 allows the user to edit a test case. Button 1006 allows the user to delete a test case. Search functionality is also provided so that the user can search for a desired test case. The search is a dynamic search which generates a new query each time a new character is entered into a search box.

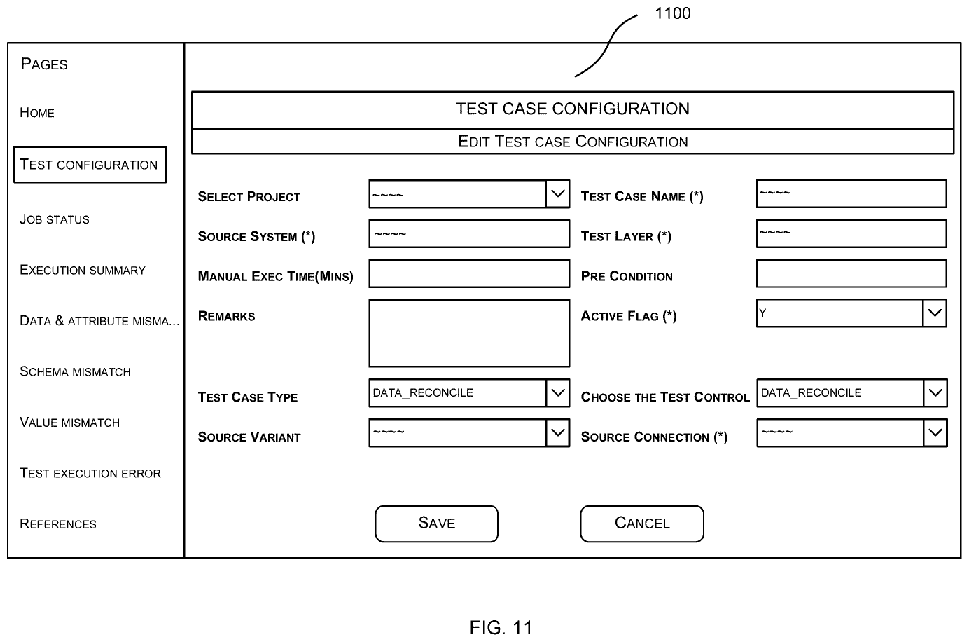

FIG. 11 is an example page 1100 in the UI which allows the user to edit a test case configuration. For example, the user arrives at this page through button 1004 in FIG. 10. The user provides test case configuration details including one or more of: project, test case name, source system, test layer, manual execution time (Manual exec time), active flag, test case type, source variant, test control, and source connection as shown in FIG. 11. Although not shown in FIG. 11 test case configuration details further include source query, target variant, target connection, primary keys and target query. In various examples, manual execution time may be 20 minutes or 40 minutes per test case. Setting a manual execution time prevents jobs running for long periods of time and wasting compute resources. In some scenarios, when a test suite containing test cases is triggered a test case will be executed based on active flag of the test case. If active flag is set to “YES”, the test case will be executed; if set to “NO”, it will not be executed. Test control is a functional library to select type of test case to be executed.

Source system, source connection, source variant and source query parameters input by the user provide details about how the core comparison engine 112 accesses source data. Target system, target connection, target variant and target query parameters input by the user provide details about how the core comparison engine 112 accesses target data. In the example in FIG. 11, the source variant is selected from a drop down menu. Target variant may also be selected from a drop down menu (not shown). Many source/target variants may be used for example Parquet as is selected in FIG. 11. Other source variants which may be selected are excel, json, binary, Database, csv. In FIG. 11, the source connection is selected from a drop down menu of configured connections. The connections are for example configured at pages 800 and 900. Target connection may also be selected from a drop down menu (not shown). Test case type includes information about the type of data validation. Examples of test case type include data reconcile, duplicate check, or null check. Based on selected test case type, core comparison engine 112 selects various functions from a function library such as function library 144 which identify the discrepancies. In the example in FIG. 11, the test case type is Data_Reconcile. When the user selects this test case type, it runs tests to compare data between the source and target systems. In further examples, when Test case type DUP_CHECK is selected, comparison engine will access the duplicate validation related functions. When user select VALUE_CHECK user, comparison engine will access singular data validation related functions.

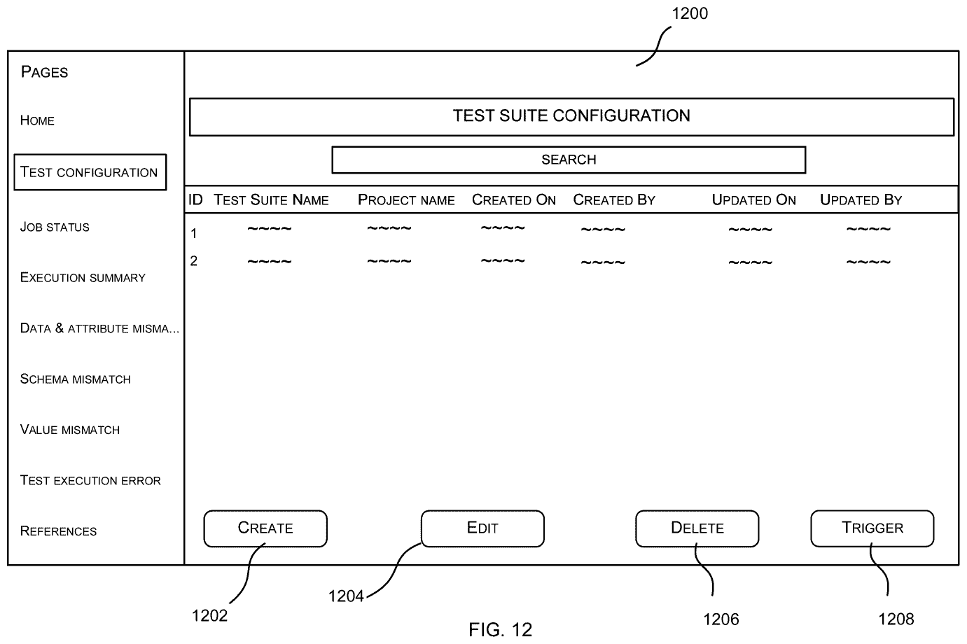

FIG. 12 shows an example of a “Test Suite Configuration” page 1200 in the UI wherein the user views test suite configuration details and provides test suite configuration details for new or existing test suites. In an example scenario, the user has navigated to the “Test suite Configuration” page from the “Test Configuration” page. Each test suite is associated with a project and this information is displayed at page 1200. “Test suite Configuration” page 1200 shows various test suites which have been configured. Button 1202 allows the user to create a new configuration. Button 1204 allows the user to edit a test suite. Button 1206 allows the user to delete a test suite. Search functionality is also provided so that the user can search for a desired test suite. The search is a dynamic search which generates a new query each time a new character is entered into a search box. When the user is ready to trigger test execution via a data pipeline, they may do so by selecting one or more test suites and pressing trigger button 1208 in page 1200.

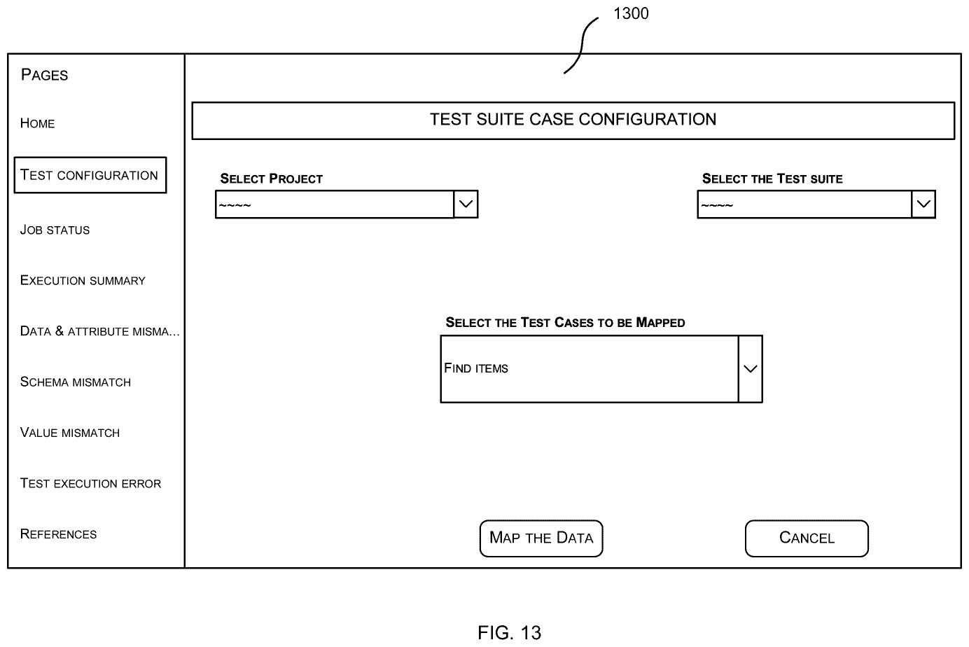

FIG. 13 shows an example page of the UI for Test Suite Case Configuration 1300. Page 1300 allows a user to map one or more test cases to a test suite. At page 1300 the user selects the project to which the test suite and test case(s) belong. The user also selects the test suite. In the Example shown in FIG. 13, the project and the test suite are selected from drop down menus. A dropdown menu displays the previously configured projects for the user to select from, wherein the project configuration details are stored in the tool database. Another dropdown menu displays the previously defined test suites for the user to select from, details of which are stored in the tool database. The user selects test cases to be mapped to the test suite selected. In the example shown, the test cases to be mapped are selected from a drop down menu. The drop down menu contains the names of test cases configured for example at pages 1000 and 1100 of the UI. The user may select the “Map the Data” button in order to configure the test suite and map the selected test cases to the test suite.

Once the program, project, test case(s) and test suite(s) have been configured, configuration details are stored in tool database 110. The user triggers the execution of one or more test suites for example by pressing trigger button 1208. During and after job execution, test execution results such as 140 are displayed for the user within the user interface. Displaying test execution details within the same UI as the one which was used to provide configuration details and to facilitate the user triggering job execution makes running tests more easy and efficient for the user.

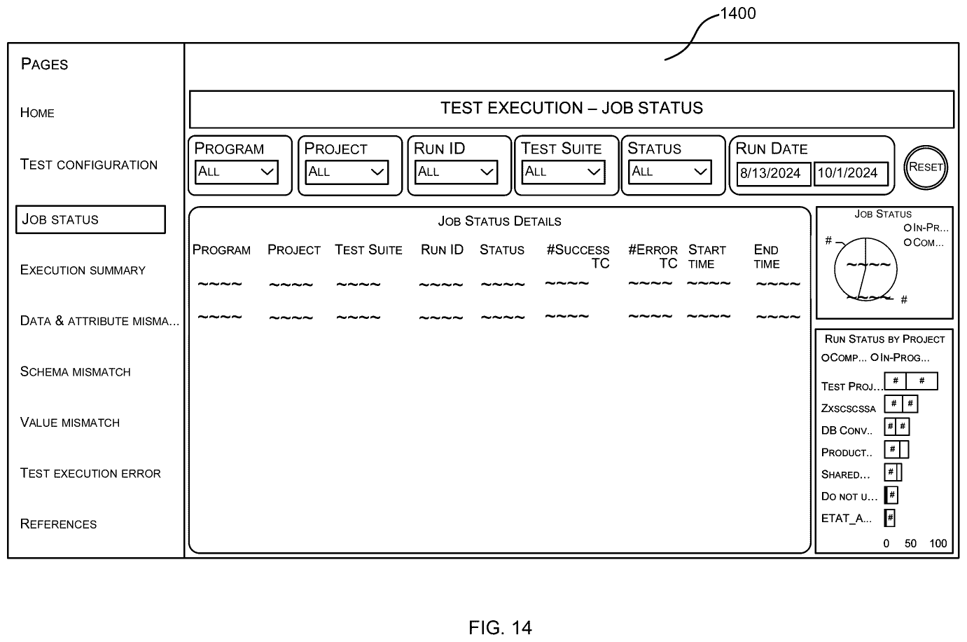

FIG. 14 shows an example page 1400 of the UI which includes information about Test Execution and Job Status. Displayed in page 1400 are test execution details. The user views information regarding test execution jobs. The information displayed may include but is not limited to: Program, project, test suite, run ID, Status, number of successful test cases (#successTC), number of test cases which have thrown errors (#ErrorTC), start time and end time. In various examples, one row contains the information for each test suite. The page 1400 is displayed after selecting the Job Status page from the menu on the left side of the UI.

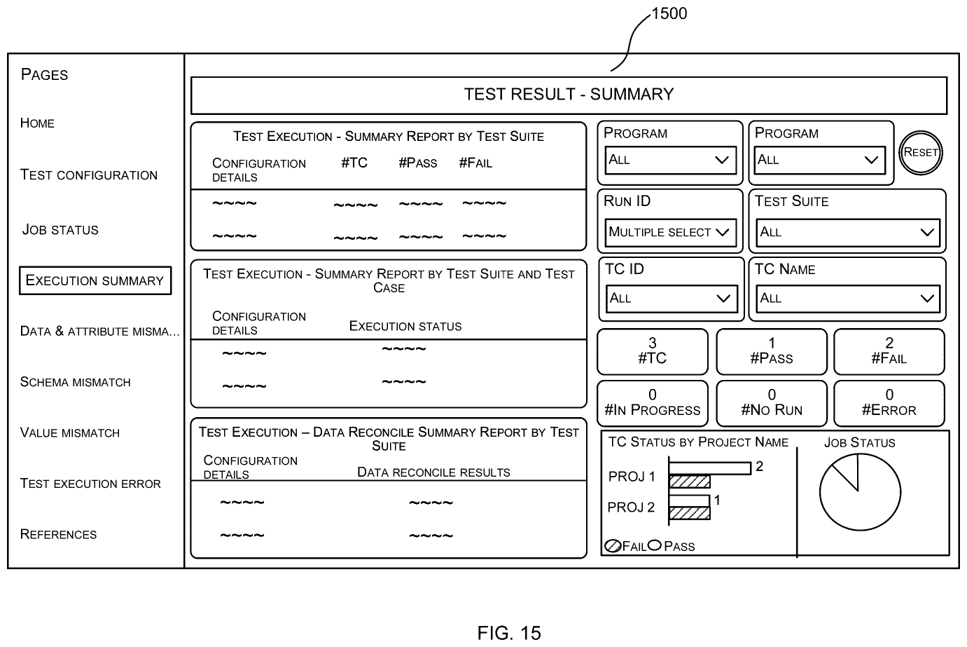

The UI also displays discrepancy test results such as 138 so that the user may view discrepancy results in the same application as the one which is used to provide configuration details and view test execution details. FIG. 15 shows a page 1500 which is used display a test results summary. The summary page displays a summary of discrepancy results. Included in the example summary page are panels including a test execution summary report by test suite, which displays configuration details along with the number of test cases in the test suite (#TC), the number of passes (#Pass) and number of fails (#Fail). Also included in the example page is a panel giving a test execution summary report by test suite and test case. This provides details on execution status such as whether the execution passed or failed organized by individual test cases. In the example in FIG. 15, the user has selected data reconcile as a test case type. A data reconcile summary report by test case is displayed including configuration details and data reconcile results.

On the right side of page 1500 the user may provide input which determines what information is displayed to the user. Also displayed on the right side of the UI page 1500 are panels providing key information to the user regarding test execution results and discrepancy results. Total number of test cases which have finished running (#TC) is displayed along with the total number of passes (#Pass) and total number of fails (#Fail) of the test cases. Also displayed is information on the number of test cases in progress (#In progress), the number of test cases which have not finished running (#No run), and the number of test cases which have produced errors (#Error). A bar chart displaying key pass and fail information to the user. The bar chart displays, by project name, the number of test cases which are passed and the number of test cases which are failed. A pie chart shows the proportion of jobs status which have success and failed.

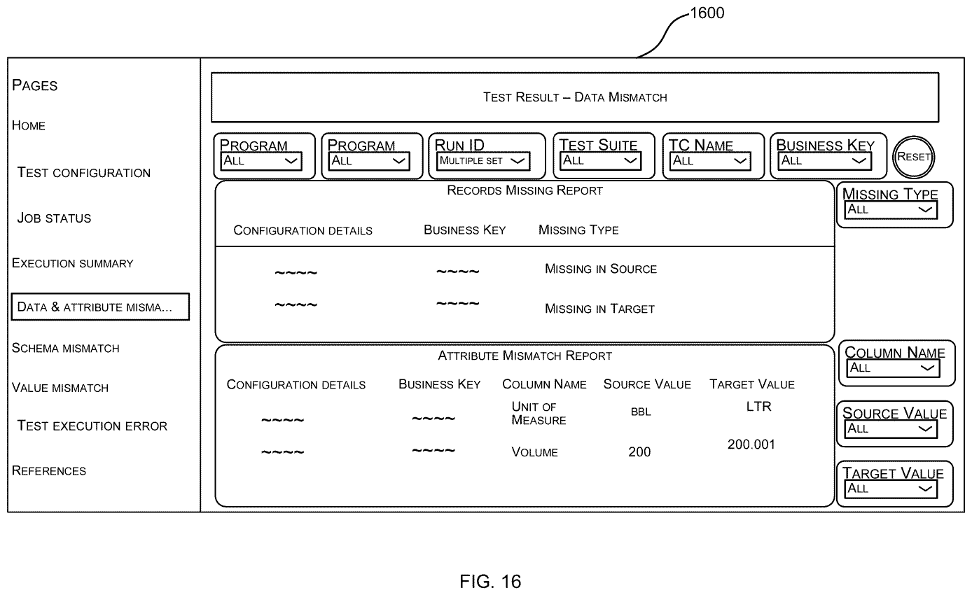

Within the UI, the user may select from one of the following pages in order to view detailed discrepancy results: Data & Attribute mismatch, Schema mismatch, and value mismatch. FIG. 16 is an example of a Data & Attribute mismatch page called “Test result-Data mismatch” 1600. As used herein, discrepancy and mismatch are interchangeable. This page displays missing record discrepancies and attribute discrepancies. Under “Missing Type”, the page displays whether an identified record is missing in source data and target data. In the attribute mismatch report, the UI identifies the row in source and target data with a mismatch via a primary key, and column name identifies the column with the mismatch. Source value and target value are displayed for comparison. Along the top of page 1600 the user may choose parameters including program, project which allows the user to select which tests to display discrepancy results for in the page.

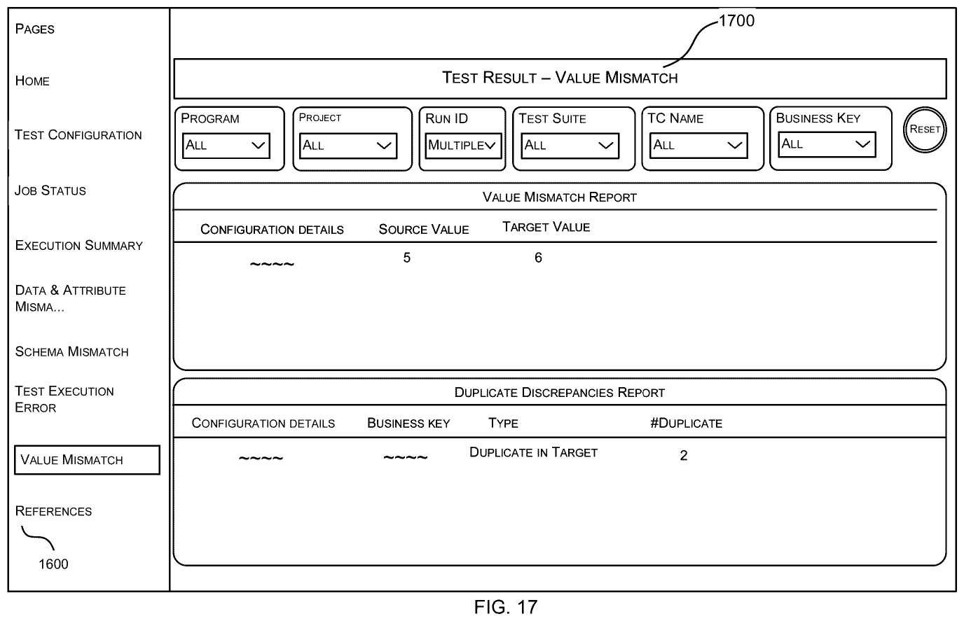

FIG. 17 is an example of a value mismatch page called “Test result-Value mismatch” 1700. This page displays value discrepancies and duplicate discrepancies. In a duplicate discrepancies report, the number of times a record is duplicated is displayed (#Duplicate) as well as the type of duplicate i.e. whether a record identified via a primary key and other configuration details is duplicated in source or target data. A value discrepancy report displays source values and target values for comparison. The values are the number of rows in source data and target data respectively. Along the top of page 1700 the user may choose parameters including program, project which allows the user to select which tests to display discrepancy results for in the page.

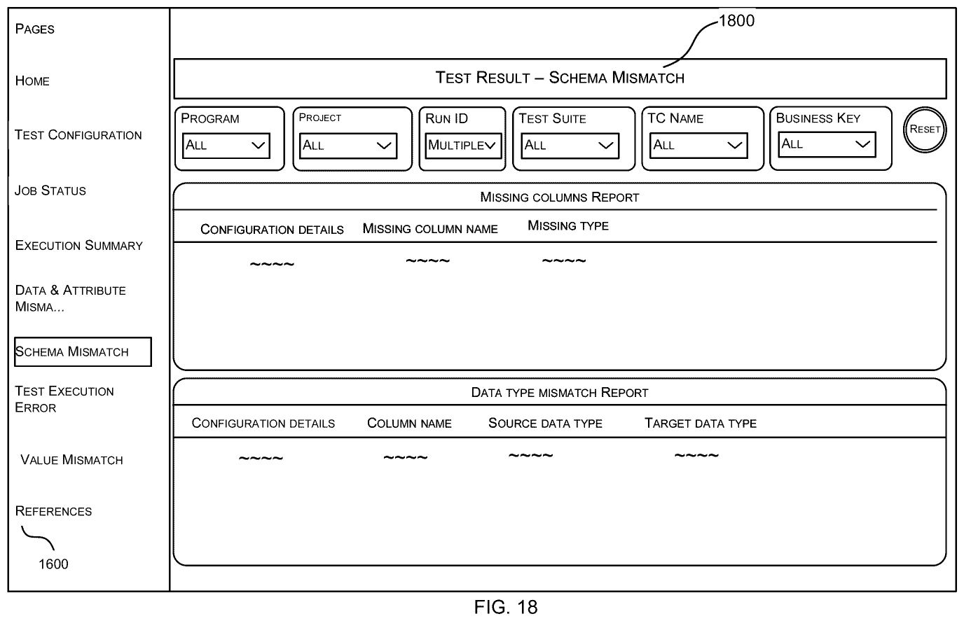

FIG. 18 is an example of a value mismatch page called “Test result-schema mismatch” 1800. This page displays missing column discrepancies and data type discrepancies. In a missing column discrepancies report, missing columns in source or target data are identified. Missing type is displayed, which in this example takes one of two values: “missing in source”, or “missing in target”. The missing column name is also displayed along with configuration details identifying the test case, project and program. A data type discrepancy report displays a source data type and target data type for comparison. Column name identifies the column in source and target data with a data type mismatch. Along the top of page 1800 the user may choose parameters including program, project which allows the user to select which tests to display discrepancy results for in the page.

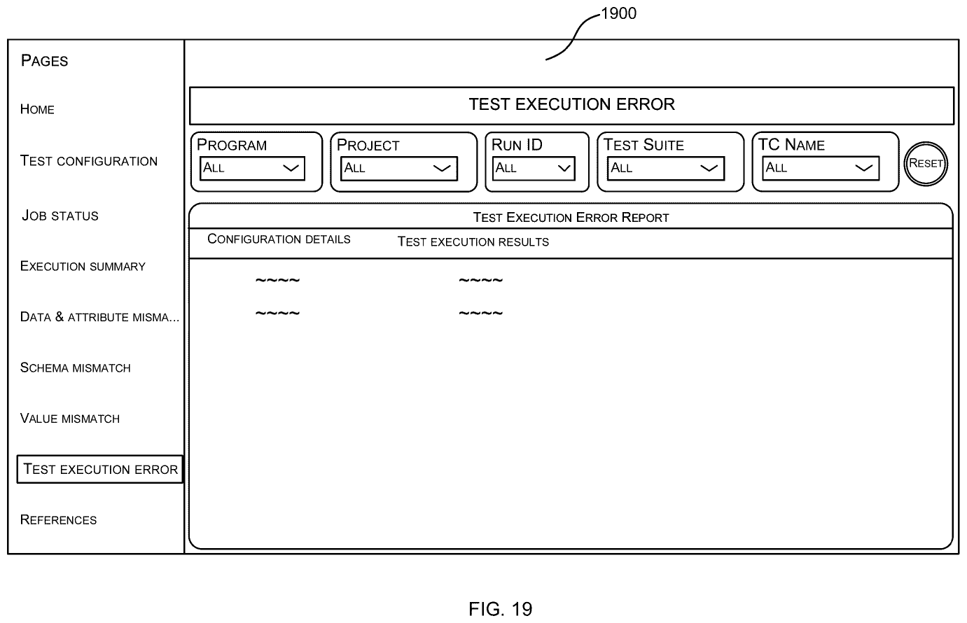

FIG. 19 is an example of a “Test Execution Error” page 1900 which provides detailed information regarding test execution. It displayed test configuration details which allows the user to identify the test which has thrown an error during execution. It also provides the user with an error description (“Error Desc”) which is provided by core comparison engine 112 and is stored and read from tool database 110. The error description provides detailed information to the user which allows the user to fix the error. By displaying test execution error information in such a manner, the user is able to quickly and efficiently identify errors in the given configuration details (e.g. syntax error in the source/target query, invalid connection details). At the top of page 1900 the user provides input as to which test results to display on the page.

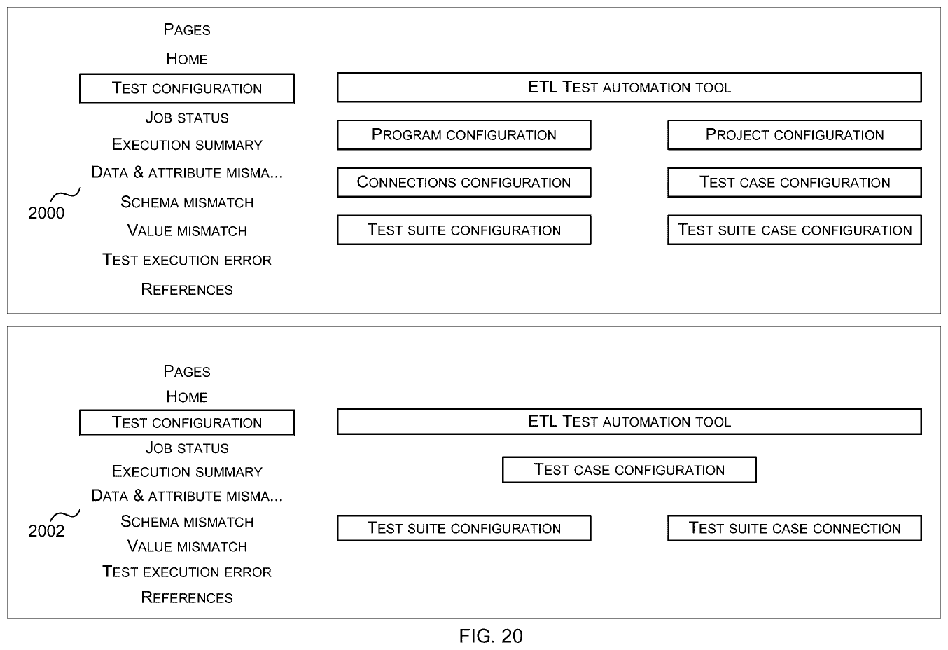

FIG. 20 shows two pages of the UI 2000 and 2002. 2000 shows a page for configuring details regarding ETL testing which is also shown in FIG. 5. The page is accessible to a first user of the tool. The first user is a tool administrator who has permissions to configure programs, projects, connections, test cases and test suites, and test suite case connections. By contrast 2002 shows another page of the UI for configuring details. Page 2002 allows a user to configure test cases, test suites and test suite case connections. The user of page 2002 is a second user who is not a tool administrator. The second user is for example a project administrator who is able to configure tests and test suites for the project to which they have permission to access. A third example user is not a tool administrator or a project administrator, but is for example a viewer. The viewer is not able to configure any programs, projects, tests or test suites but is able to view test execution results and test discrepancy results.

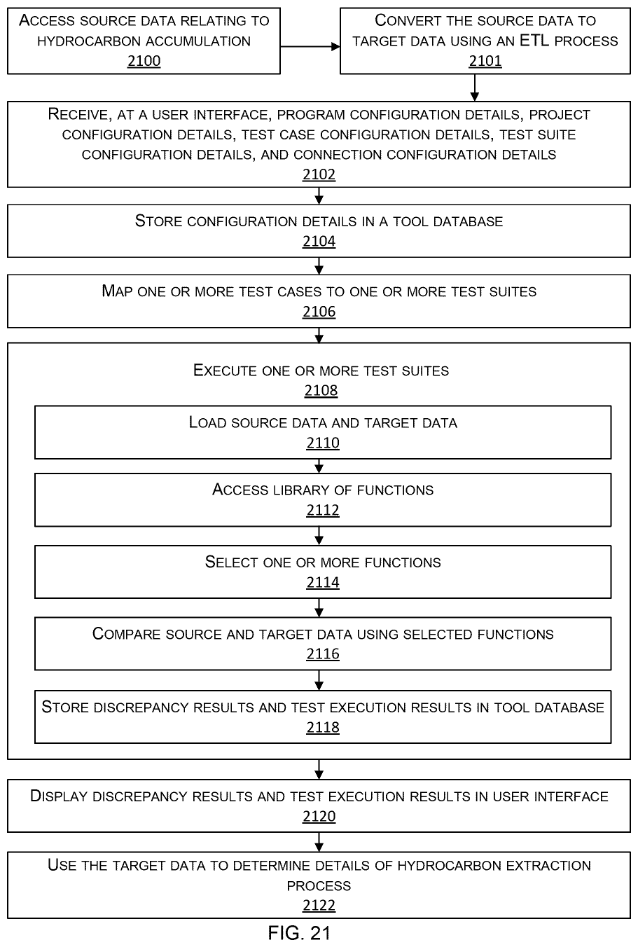

FIG. 21 is a flowchart depicting a computer-implemented method for testing an extract, transform, load (ETL) process, wherein the ETL process converts source data to target data. At 2102, configuration details are received at a user interface. The configuration details are: program configuration details, project configuration details, test case configuration details, test suite configuration details, wherein a test suite comprises one or more test cases, and connection configuration details comprising source data system and target data system information. At 2104, configuration details are stored in a tool database. One or more test cases are mapped to one or more test suites at 2106. At 2108, one or more test suites are executed. Executing the one or more test suites comprises loading the source data from the source data system and the target data from the target data system into memory 2110 for validation. A library of functions is accessed 2112 and one or more functions is selected 2114 from the library of functions. At 2116, the source data and target data are compared using the selected function. Comparing source and target data produces discrepancy results. Discrepancy results as well as test execution results are stored in a tool database 2118. At 2120 discrepancy results and test execution results are displayed at the user interface. Although not shown in FIG. 21, some example methods include automatically updating the ETL process based on discrepancy results.

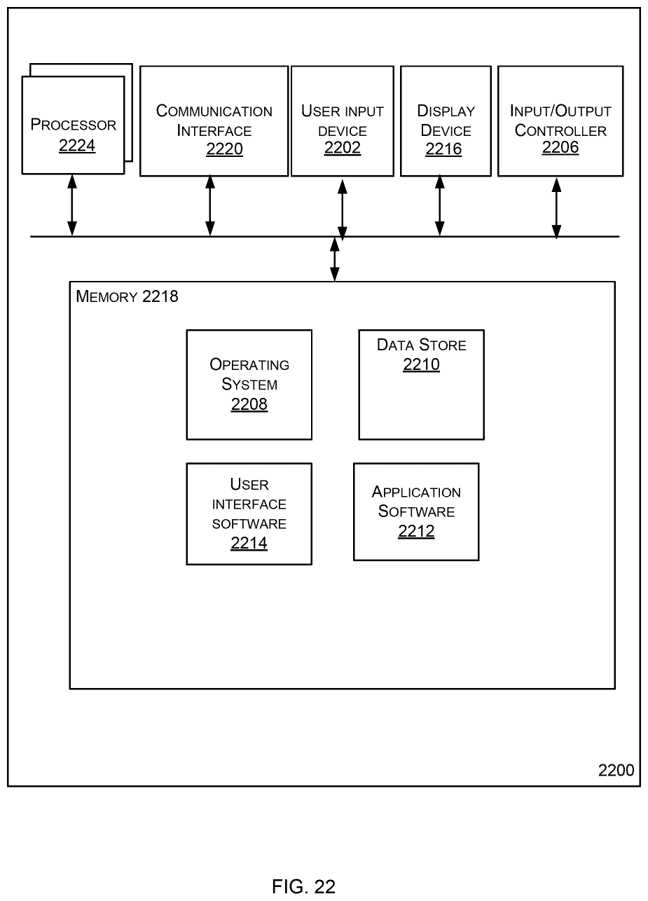

FIG. 22 illustrates an example computing-based device which performs some or processes described herein. Computing-based device 2200 comprises one or more processors 2224 which are microprocessors, controllers, or any other suitable type of processors for processing computer executable instructions to control the operation of the. In some examples, for example where a system on a chip architecture is used, the processors 1024 include one or more fixed function blocks (also referred to as accelerators) which implement a part of the methods disclosed herein in hardware (rather than software or firmware). Platform software comprising an operating system 2208 or any other suitable platform software is provided at the computing-based device to enable application software 2212 to be executed on the device. A data store 2210 holds relevant data. In various examples user interface software 2214 is provided at the computing device.

Computer executable instructions are provided using any computer-readable media that are accessible by computing based device 2200. Computer readable media include, for example, computer storage media such as memory 2218 and communications media. Computer storage media, such as memory 2218, include volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 2218) is shown within the computing-based device 1000 it will be appreciated that the storage is, in some examples, distributed or located remotely and accessed via a network or other communication link (e.g. using communication interface 2220).

The computing-based device 2200 also comprises an input/output controller 2206 arranged to output display information to a display device 2216 which may be separate from or integral to the computing-based device 2200. The input/output controller 1006 is also arranged to receive and process input from one or more devices, such as a user input device 2202 (e.g. a mouse, keyboard, camera, microphone or other sensor). In some examples the user input device 2202 detects voice input, user gestures or other user actions and provides a natural user interface (NUI). This user input may be used for example to define configuration details. In an embodiment the display device 2216 also acts as the user input device 2202 if it is a touch sensitive display device. The input/output controller 2206 outputs data to devices other than the display device in some examples, e.g. a locally connected printing device (not shown in FIG. 22).

Any of the input/output controller 2206, display device 2216 and the user input device 2202 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively, or in addition, the functionality described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Alternatively or in addition to the other examples described herein, examples include any combination of the following:
Clause A. A computer-implemented method for testing an extract, transform, load (ETL) process, wherein the ETL process converts source data to target data, the method comprising:
receiving at a user interface:
program configuration details,
project configuration details,
test case configuration details,
test suite configuration details, wherein a test suite comprises one or more test cases, and
connection configuration details comprising source data system and target data system information;
storing the configuration details in a tool database;
mapping one or more test cases to one or more test suites;
executing the one or more test suites, wherein the executing comprises:
loading the source data from the source data system and the target data from the target data system into memory,
accessing a library of functions,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy, a duplicate discrepancy.
Clause B. The method of clause A wherein displaying discrepancy results comprises displaying a summary of discrepancy results and a detailed report of discrepancy results.
Clause C. The method of clause A or clause B wherein displaying test execution results comprises displaying a summary of test execution results and a detailed report of test execution results.
Clause D. The method of any preceding clause wherein a first user provides, at the user interface the program configuration details and wherein one or more of: the project configuration details, test case configuration details, test suite configuration details and connection configuration details are provided by the first user or a second user and wherein the second user does not have permission to provide program configuration details.
Clause E. The method of clause D further comprising displaying the discrepancy results and test execution results to a third user wherein the third user does not have permission to provide any configuration details.
Clause F. The method of any preceding clause wherein executing the one or more test suites comprises executing a first test suite and a second test suite in parallel.
Clause G. The method of any preceding clause further comprising receiving a search query, and in response to the search query, returning one or more of: program information, project information, connection information, test suite information. test case information.
Clause H. The method of any preceding clause further comprising automatically updating the ETL process using the discrepancy results.
Clause I. The method of any preceding clause wherein the source data and target data are one or more of: data relating to resource extraction, data from a sensor, data from a camera, data from a temperature sensor, data from a remote device, data from an internet of things device.
Clause J. The method of any preceding clause wherein the source system and/or the target system is a database system or a file system.
Clause K. The method of any preceding clause wherein the source data and/or the target data is in one of the following data formats: binary, json, excel, parquet, csv, database.
Clause L. The method of any preceding clause wherein displaying discrepancy results comprises: displaying a missing record discrepancy report and an attribute discrepancy report in a page of the user interface; displaying a value discrepancy report and a duplicate discrepancy report in a second page of the user interface; and displaying a missing column discrepancy report and a data type discrepancy report in a third page of the user interface.
Clause M. The method of any preceding clause wherein
a missing record discrepancy includes information about whether a record is missing in source data, missing in target data and a primary key identifying the missing record;
an attribute discrepancy includes a primary key, a source value and a target value, and a column name
a missing column discrepancy includes information about whether a column is missing in source data, missing in target data, and a column name identifying the column
a data type discrepancy includes information about a source data type, a target data type and a column name,
a value discrepancy includes information about the number of records in source and target data
a duplicate discrepancy includes information about whether a record is duplicated in source data, duplicated in target data, the number of times a record is duplicated and a primary key.
Clause N. The method of claim 1, wherein the one or more test suites are executed using the library of functions in a notebook, and wherein an execution job is triggered through a data pipeline, and further wherein discrepancy results and test execution results are stored in an SQL database.
Clause O. The method of any preceding clause wherein reuseable functions in the function database comprise one or more of the following functions: a function to read source data, a function to read target data, a function to write discrepancy results to the tool database, a function to compare a schema of the source data with a schema of the target data, a function to compare values between source data and target data, a function to find duplicate records.
Clause P. An apparatus comprising:
a processor;
a memory storing instructions that, when executed by the processor, perform a method for testing an extract, transform, load (ETL) process, wherein the ETL process converts source data to target data, the method comprising:
receiving at a user interface:
program configuration details,
project configuration details,
test case configuration details,
test suite configuration details, wherein a test suite comprises one or more test cases,
connection configuration details comprising source data system and target data system information;
storing the configuration details in a tool database;
mapping one or more test cases to one or more test suites;
executing the one or more test suites, wherein the executing comprises:
loading the source data from the source data system and the target data from the target data system into memory,
accessing a library of functions,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy,
a duplicate discrepancy.
Clause Q. The apparatus of clause P wherein a first user provides, at the user interface the program configuration details and wherein one or more of: the project configuration details, test case configuration details, test suite configuration details and connection configuration details are provided by the first user or a second user and wherein the second user does not have permission to provide program configuration details.
Clause R. The apparatus of clause P or Q wherein the method further comprises automatically updating the ETL process using the discrepancy results.
Clause S. The apparatus clause P, Q or R wherein the source data and target data are one or more of: data relating to resource extraction, data from a sensor, data from a camera, data from a temperature sensor, data from a remote device, data from an internet of things device.
Clause T. A computer-implemented method for comparing a source dataset and a target dataset, the method comprising:
receiving at a user interface:
program configuration details,
project configuration details,
test case configuration details,
test suite configuration details, wherein a test suite comprises one or more test cases, and
connection configuration details comprising source data system and target data system information;
storing the configuration details in a tool database;
mapping one or more test cases to one or more test suites;
executing, at a core comparison engine the one or more test suites, wherein the executing comprises:
loading the source data from the source data system and the target data from the target data system into memory,
accessing a library of functions stored in the tool database,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy,
a duplicate discrepancy.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method for testing an extract, transform, load (ETL) process, wherein the ETL process converts source data to target data, the method comprising:
receiving at a user interface:
program configuration details,
project configuration details,
test case configuration details,
test suite configuration details, wherein a test suite comprises one or more test cases, and
connection configuration details comprising source data system and target data system information;
storing the configuration details in a tool database;
mapping one or more test cases to one or more test suites;
executing the one or more test suites, wherein the executing comprises:
loading the source data from the source data system and the target data from the target data system into memory,
accessing a library of functions,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy,
a duplicate discrepancy.

2. The method of claim 1 wherein displaying discrepancy results comprises displaying a summary of discrepancy results and a detailed report of discrepancy results.

3. The method of claim 1 wherein displaying test execution results comprises displaying a summary of test execution results and a detailed report of test execution results.

4. The method of claim 1 wherein a first user provides, at the user interface the program configuration details and wherein one or more of: the project configuration details, test case configuration details, test suite configuration details and connection configuration details are provided by the first user or a second user and wherein the second user does not have permission to provide program configuration details.

5. The method of claim 4 further comprising displaying the discrepancy results and test execution results to a third user wherein the third user does not have permission to provide any configuration details.

6. The method of claim 1 wherein executing the one or more test suites comprises executing a first test suite and a second test suite in parallel.

7. The method of claim 1 further comprising receiving a search query, and in response to the search query, returning one or more of: program information, project information, connection information, test suite information, test case information.

8. The method of claim 1 further comprising automatically updating the ETL process using the discrepancy results.

9. The method of claim 1 wherein the source data and target data are one or more of: data relating to resource extraction, data from a sensor, data from a camera, data from a temperature sensor, data from a remote device, data from an internet of things device.

10. The method of claim 1 wherein the source system and/or target system is a database system or a file system.

11. The method of claim 1 wherein the source data and/or target data are in one of the following data formats: binary, json, excel, parquet, csv, database.

12. The method of claim 1 wherein displaying discrepancy results comprises:
displaying a missing record discrepancy report and an attribute discrepancy report in a page of the user interface; displaying a value discrepancy report and a duplicate discrepancy report in a second page of the user interface; and displaying a missing column discrepancy report and a data type discrepancy report in a third page of the user interface.

13. The method of claim 1, wherein
a missing record discrepancy includes information about whether a record is missing in source data, missing in target data and a primary key identifying the missing record;
an attribute discrepancy includes a primary key, a source value and a target value, and a column name
a missing column discrepancy includes information about whether a column is missing in source data, missing in target data, and a column name identifying the column
a data type discrepancy includes information about a source data type, a target data type and a column name,
a value discrepancy includes information about the number of records in source and target data
a duplicate discrepancy includes information about whether a record is duplicated in source data, duplicated in target data, the number of times a record is duplicated and a primary key.

14. The method of claim 1, wherein the one or more test suites are executed using the library of functions in a notebook, and wherein an execution job is triggered through a data pipeline, and further wherein discrepancy results and test execution results are stored in an SQL database.

15. The method of claim 1 wherein reuseable functions in the function database comprise one or more of the following functions: a function to read source data, a function to read target data, a function to write discrepancy results to the tool database, a function to compare a schema of the source data with a schema of the target data, a function to compare values between source data and target data, a function to find duplicate records.

16. An apparatus comprising:
a processor;
a memory storing instructions that, when executed by the processor, perform a method for testing an extract, transform, load (ETL) process, wherein the ETL process converts source data to target data, the method comprising:
receiving at a user interface:
program configuration details,
project configuration details,
test case configuration details,
test suite configuration details, wherein a test suite comprises one or more test cases,
connection configuration details comprising source data system and target data system information;
storing the configuration details in a tool database;
mapping one or more test cases to one or more test suites;
executing the one or more test suites, wherein the executing comprises:
loading the source data from the source data system and the target data from the target data system into memory,
accessing a library of functions,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy,
a duplicate discrepancy.

17. The apparatus of claim 16 wherein a first user provides, at the user interface the program configuration details and wherein one or more of: the project configuration details, test case configuration details, test suite configuration details and connection configuration details are provided by the first user or a second user and wherein the second user does not have permission to provide program configuration details.

18. The apparatus of claim 16 wherein the method further comprises automatically updating the ETL process using the discrepancy results.

19. The apparatus of claim 16 wherein the source data and target data are one or more of: data relating to resource extraction, data from a sensor, data from a camera, data from a temperature sensor, data from a remote device, data from an internet of things device.

20. A computer-implemented method for comparing a source dataset and a target dataset, the method comprising:
receiving at a user interface:
program configuration details,
project configuration details,
test case configuration details,
test suite configuration details, wherein a test suite comprises one or more test cases, and
connection configuration details comprising source data system and target data system information;
storing the configuration details in a tool database;
mapping one or more test cases to one or more test suites;
executing, at a core comparison engine the one or more test suites, wherein the executing comprises:
loading the source data from the source data system and the target data from the target data system into memory,
accessing a library of functions stored in the tool database,
selecting one or more functions from the library of functions,
comparing the source data with the target data using the selected functions, wherein the comparing produces discrepancy results,
storing discrepancy results in the tool database, and
storing test execution results in the tool database;
displaying the discrepancy results and the test execution results in the user interface, wherein the discrepancy results include information relating to one or more of the following:
a missing record discrepancy,
an attribute discrepancy,
a missing column discrepancy,
a data type discrepancy,
a value discrepancy,
a duplicate discrepancy.
